(19) United States
(12) Patent Application Publication
(10) Pub. No.: US 2015/0007797 A1
(43) Pub. Date: Jan. 8, 2015

(54) FUEL SYSTEM WITH PRIORITY VALVE

(71) Applicant: Caterpillar Inc., Peoria, IL (US)

(72) Inventor: Chad F. Ahmad, Peoria, IL (US)

(73) Assignee: Caterpillar Inc., Peoria, IL (US)

(21) Appl. No.: 14/494,585

(22) Filed: Sep. 23, 2014

(51) Int. Cl. F02M 31/20

(52) U.S. Cl. CPC F02M 31/205
USPC 123/472

(57) ABSTRACT

A method for operating a fuel system for an internal combustion engine during engine start, is disclosed. The fuel system includes a fuel supply system in fluid communication with a fuel delivery system and a cooling circuit. The cooling circuit is configured to transfer heat from the fuel delivery system. The method includes provision of fuel to the fuel delivery system and isolation of the fuel from the cooling circuit. Thereafter, a pressure between the fuel supply system and the fuel delivery system is sensed. Determination is carried out when the pressure is greater than a predetermined threshold fuel pressure. Subsequently, based on the determined pressure, fuel to the cooling circuit is provided.

### TECHNICAL FIELD

The present disclosure generally relates to a fuel system for an internal combustion engine of a machine. More specifically the present disclosure relates to the fuel system with a priority valve in the internal combustion engine of the machine.

### BACKGROUND

An internal combustion engine is well known in the art as a power source for various machines. A crank of the internal combustion engine may be rotated to start the internal combustion engine. Crank rotation may be performed by an electric motor or by manual intervention. The process of rotating the crank by the above stated means may be termed as cranking The time required to start the internal combustion engine may be termed as cranking time. A fuel is supplied to the internal combustion engine during cranking to start the combustion. The fuel may be supplied by a fuel system. Fuel systems generally include fuel injectors, fuel pumps, common rails, and the like.

Such fuel systems may require to be cooled during the operation of the internal combustion engine by use of a cooling fluid. The cooling fluid may include engine coolant or fuel. When fuel is used as a coolant, a portion of the fuel supplied by a fuel pump is diverted to a related cooling circuit. However, during engine cranking, the diversion of fuel may increase the time duration for a threshold pressure build-up. As the time taken to achieve the threshold fuel pressure increases, the internal combustion engine takes more time to start the operation.

Various solutions have been developed to address the challenges cited above. The present disclosure is directed towards overcoming the above-stated challenges.

### SUMMARY OF THE DISCLOSURE

The present disclosure provides a method for operating a fuel system for an internal combustion engine during an engine start. The fuel system includes a fuel supply system in fluid communication with a fuel delivery system and a cooling circuit. The cooling circuit is configured to transfer heat from the fuel delivery system. The method includes a provision of fuel to the fuel delivery system and an isolation of the fuel from the cooling circuit. Next, detection of a pressure between the fuel supply system and the fuel delivery system is carried out. Thereafter, by determining that the pressure is greater than a predetermined threshold fuel pressure, fuel is provided to the cooling circuit.

### BRIEF DESCRIPTION OF DRAWINGS

FIG. 1 illustrates a schematic block diagram of a fuel system for an internal combustion engine, in accordance with the concepts of the present disclosure;

FIG. 2 illustrates a schematic block diagram of the fuel system for the internal combustion engine in an alternate embodiment, in accordance with the concepts of the present disclosure;

FIG. 3 illustrates a schematic block diagram of the fuel system for the internal combustion engine in an alternative embodiment, in accordance with the concepts of the present disclosure; and

FIG. 4 illustrates a flow chart, which describes a method of operating the fuel system for the internal combustion engine, in accordance with the concepts of the present disclosure.

### DETAILED DESCRIPTION

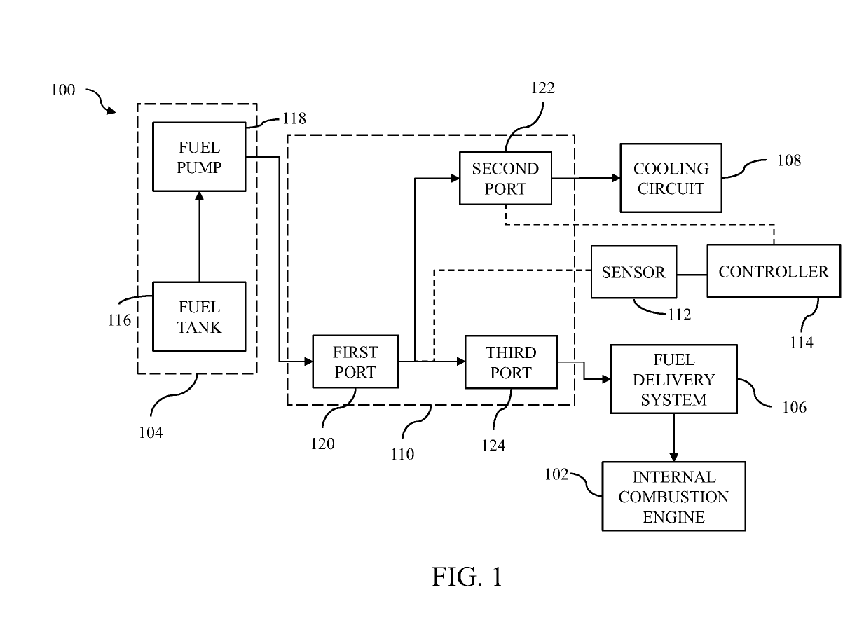

FIG. 1 illustrates a block diagram of a fuel system 100 for an internal combustion engine 102, in accordance with the concepts of the present disclosure. In reference to FIG. 1, the fuel system 100 may include a fuel supply system 104, a fuel delivery system 106, a cooling circuit 108, a priority valve 110, a sensor 112 and a controller 114.

The fuel supply system 104 may further comprise a fuel tank 116 and a fuel pump 118. The fuel tank 116 is configured to store the fuel. The fuel stored may be a liquid fuel such as petrol, diesel, a gaseous fuel, liquefied natural gas, hydrogen, and/or the like. Further, the fuel pump 118 supplies the fuel from the fuel tank 116 to the fuel delivery system 106 and the cooling circuit 108. The fuel supply system 104 stores and supplies fuel for operations of the internal combustion engine 102.

In an embodiment, the fuel may flow through a fuel filter (not shown), which may be located either upstream or downstream of the fuel pump 118. The fuel filter (not shown) may be configured to screen impurities, such as dirt, rust, debris, and/or the like, from the fuel. The fuel filter (not shown) may be a plastic filter, a paper filter, coil-type filter, and/or the like. Other filter types may be contemplated, as apparent to those of skill in the art. When positioned downstream of the fuel pump 118, the fuel filter (not shown) may provide relatively clean fuel to the fuel delivery system 106 and the cooling circuit 108.

The fuel delivery system 106 is configured to inject fuel into a combustion chamber of the internal combustion engine 102 at relatively high pressure. The fuel delivery system 106 may include various components, such as, but not limited to, a high-pressure pump, a common rail, a high-pressure line, and one or more fuel injectors. The high-pressure pump may facilitate fuel supply to the fuel injector, via the high-pressure line. The injection of the fuel at high pressure may atomize the fuel within the combustion chamber of the internal combustion engine 102. Atomization of the fuel by the fuel injector may result in improved power output, improved efficiency, and reduced maintenance of the internal combustion engine 102.

The cooling circuit 108 is configured to transfer heat away from the fuel delivery system 106, thereby cooling the fuel delivery system 106. The cooling circuit 108 may cool one or more of the common rail, the high-pressure line, and/or the fuel injector of the fuel delivery system 106. In an embodiment, the cooling circuit 108 allows the fuel to flow around the high-pressure line of the fuel delivery system 106. The fuel flow around the high-pressure line dissipates the heat from the high-pressure line, which results in cooling of the fuel inside the high-pressure line.

The priority valve 110 is positioned between the fuel supply system 104 and the cooling circuit 108. The priority valve 110 selectively allows the fuel flow from the fuel supply system 104 to the cooling circuit 108, when a pressure between the fuel supply system 104 and the fuel delivery system 106 is greater than a threshold fuel pressure.

In an exemplary embodiment, the priority valve 110 is a three-way valve. The priority valve 110 includes a first port 120, a second port 122, and a third port 124. The first port 120 is in fluid communication with the fuel supply system 104. The first port 120 receives fuel from the fuel supply system 104. The second port 122 is in fluid communication with the cooling circuit 108. This implies that the second port 122 directs the fuel to the cooling circuit 108 from the fuel supply system 104. The third port 124 is in fluid communication with the fuel delivery system 106 and directs the fuel to the fuel delivery system 106.

The sensor 112 may be operably coupled to the priority valve 110. The sensor 112 may be configured to detect the pressure between the first port 120 and the third port 124 of the priority valve 110. The sensor 112 may monitor the pressure between the fuel supply system 104 and the fuel delivery system 106.

The controller 114 may be configured to regulate the flow between the first port 120 and one or more of the second port 122 and the third port 124. The controller 114 may regulate the fuel flow from the first port 120 to the second port 122, based on the pressure detected by the sensor 112. The controller 114 allows the fuel flow from the first port 120 to the third port 124 throughout an operation of the internal combustion engine 102.

During the cranking of the internal combustion engine 102, the controller 114 may close the second port 122 and may restrict the fuel flow through the second port 122. As the second port 122 is closed, the fuel pumped by the fuel pump 118 is substantially directed to the third port 124 and to the fuel delivery system 106. The controller 114 may open the second port 122 once the threshold fuel pressure is detected between the first port 120 and the third port 124. Thereby, the fuel flow from the fuel supply system 104 is delivered to both the cooling circuit 108 and the fuel delivery system 106 simultaneously.

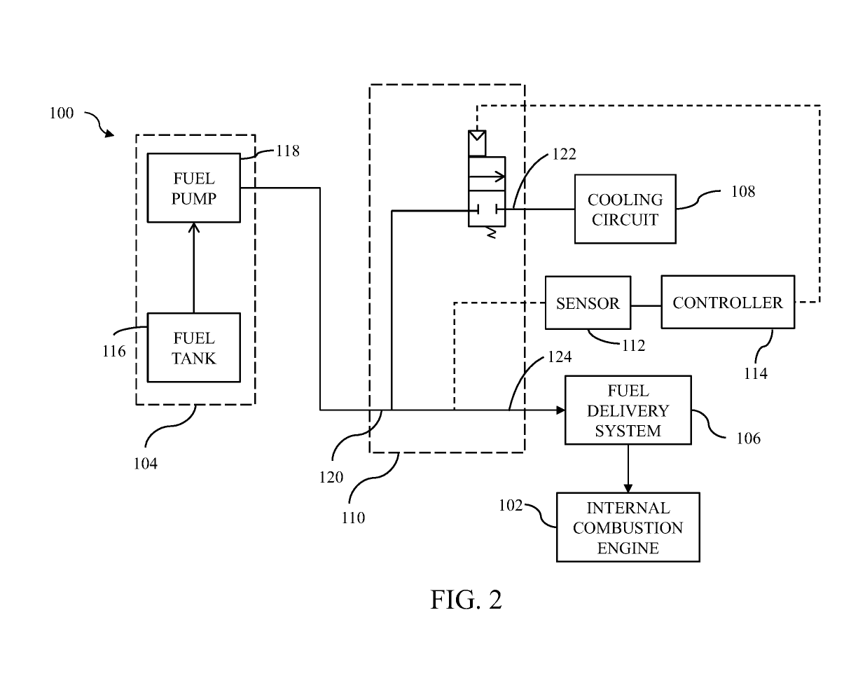

FIG. 2 illustrates a schematic block diagram of the fuel system 100 for the internal combustion engine 102 in an alternate embodiment. In this embodiment, the priority valve 110 includes an ON-OFF valve 126. The ON-OFF valve 126 may be a 2-port 2 position-direction control valve. The ON-OFF valve 126 is positioned in such a way that the ON-OFF valve 126 is in fluid communication with the fuel supply system 104 and the cooling circuit 108. The priority valve 110 restricts the fuel flow from the fuel supply system 104 to the cooling circuit 108 when the ON-OFF valve 126 is in an OFF position. The priority valve 110 allows the fuel flow from the fuel supply system 104 to the cooling circuit 108 when the ON-OFF valve 126 is in an ON position. The controller 114 controls the related positions of the ON-OFF valve 126. Moreover, the controller 114 switches the ON-OFF valve 126 in ON position when the pressure between the fuel supply system 104 and the fuel delivery system 106 is above the threshold fuel pressure.

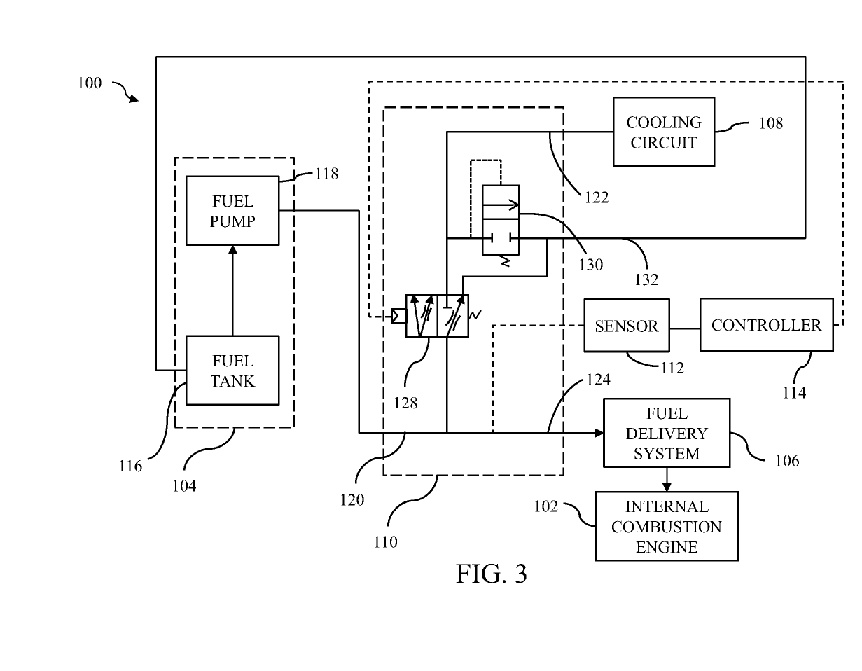

Referring to FIG. 3, an alternate embodiment of the fuel system 100 is shown. In this embodiment, the priority valve 110 includes a first two-way valve 128 and a second two-way valve 130. The first two-way valve 128 and the second two-way valve 130 may be an ON-OFF valve. It is contemplated that the first two-way valve 128 and the second two-way valve 130 may be a solenoid-actuated valve, an electro-hydraulic valve, a hydro-mechanical valve or any suitable valve thereof.

The first two-way valve 128 is positioned such that the first two-way valve 128 is in fluid communication between the fuel supply system 104 and the cooling circuit 108. In a first position of the first two-way valve 128, the priority valve 110 restricts the fuel flow to the cooling circuit 108. In a second position, however, the priority valve 110 allows the fuel flow to the cooling circuit 108. The controller 114 controls the position of the first two-way valve 128. The controller 114 switches the first two-way valve 128 in the second position when the pressure between the fuel supply system 104 and the fuel delivery system 106 is above the predetermined threshold fuel pressure. The sensor 112 may then be used to measure the pressure between the fuel supply system 104 and the fuel delivery system 106 and provide input to the controller 114.

The second two-way valve 130 is positioned between the first two-way valve 128 and a recirculation line 132 back to the fuel tank 116. The second two-way valve 130 acts as a pressure-controlling valve for the cooling circuit 108. As shown in FIG. 3, the second two-way valve 130 is pressure-actuated valve, which allows the fuel to flow to the recirculation line 132 and return to the fuel tank 116, when the pressure in the cooling circuit 108 is above a predetermined value. Thus, the second two-way valve 130 maintains the pressure level in the cooling circuit 108 at relatively lower levels. It may also be contemplated that the second two-way valve 130 may be electrically actuated. In addition, the priority valve 110 and the fuel system 100 may include additional component to enable such functionality.

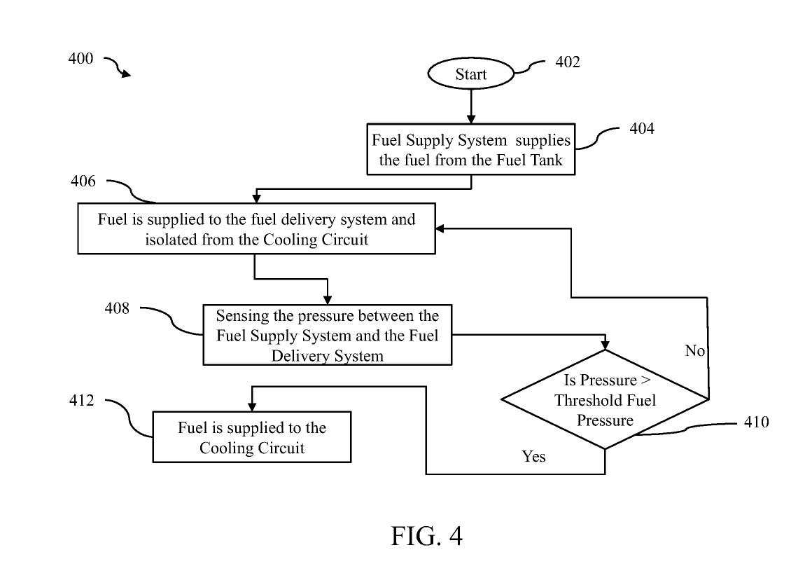

Referring to FIG. 4, a flow chart 400 is shown, which describes an exemplary method for operation of the fuel system 100 for the internal combustion engine 102, in accordance with the concepts of the present disclosure. FIG. 4 is explained in conjunction with the elements from FIG. 1, FIG. 2, and FIG. 3. The method described in FIG. 4 starts at step 402.

At step 404, the fuel pump 118 of the fuel supply system 104 pumps fuel from the fuel tank 116 to all components present downstream to the fuel pump 118. Once the fuel pump 118 pumps fuel, the method moves to step 406.

At step 406, the fuel pump 118 supplies fuel to the fuel delivery system 106 and isolates from the cooling circuit 108 using the priority valve 110. Once the step 406 is over, the method moves to step 408.

At step 408, the sensor 112 determines the pressure between the first port 120 and the third port 124, thereby determining the pressure difference between the fuel supply system 104 and the fuel delivery system 106. Once the pressure is determined the method moves to step 410.

At step 410, the determined pressure is compared with the threshold fuel pressure. If the determined pressure is less than the threshold fuel pressure, the method returns to step 406. If the determined pressure is greater than the threshold fuel pressure, the method moves to step 412.

At step 412, the fuel pump 118 supplies fuel to the cooling circuit 108 via the second port 122 of the priority valve 110. The second port 122 is closed/opened using the controller 114, based on the pressure determined in step 408. The method may conclude at step 412.

### INDUSTRIAL APPLICABILITY

In operation, the fuel system 100 initiates the supply of fuel from the fuel supply system 104 when the internal combustion engine 102 starts to crank. The fuel pump 118 of the fuel supply system 104 supplies fuel to the priority valve 110. The priority valve 110 receives the fuel through the first port 120 and directs the fuel from the first port 120 towards the second port 122 and the third port 124.

During the cranking of the internal combustion engine 102, the controller 114 is configured to keep the second port 122 of the priority valve 110 in the closed position. This restricts the fuel flow through the second port 122 into the cooling circuit 108. The controller 114 further keeps the third port 124 of the priority valve 110 in the open position and allows the fuel flow through the third port 124 to the fuel delivery system 106. At this stage, the sensor 112 may continuously measure the pressure across the first port 120 and the third port 124 of the priority valve 110. An input from the sensor 112 is provided to the controller 114. The controller 114 then facilitates opening of the second port 122, when the pressure between the fuel supply system 104 and the fuel delivery system 106 is greater than the threshold fuel pressure. This allows the fuel flow through the second port 122 to the cooling circuit 108.

Hence, the cranking time may be reduced, as the fuel flow is substantially concentrated at the third port 124 during cranking Therefore, the internal combustion engine 102 may be started in considerably short time durations by building fuel pressure at inlet of a high-pressure pump of the fuel delivery system 106.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A method for operating a fuel system for an internal combustion engine during engine start, the fuel system including a fuel supply system in fluid communication with a fuel delivery system and a cooling circuit, wherein the cooling circuit is configured to transfer heat from the fuel delivery system, the method comprising the steps of:
providing fuel to the fuel delivery system and isolating the fuel from the cooling circuit;
sensing a pressure between the fuel supply system and the fuel delivery system;
determining that the pressure is greater than a predetermined threshold fuel pressure; and
providing fuel to the cooling circuit based on the determined pressure.
